(19) United States
(12) Patent Application Publication
(10) Pub. No.: US 2014/0000743 A1
(43) Pub. Date: Jan. 2, 2014

(54) PIPE REPAIR CLAMP ASSEMBLY

(71) Applicant: Victaulic Company, Easton, PA (US)

(72) Inventors: Wayne M. Biery, Center Valley, PA (US); Audun Klath, Fort McMurray (CA)

(21) Appl. No.: 13/928,924

(22) Filed: Jun. 27, 2013

Related U.S. Application Data
(60) Provisional application No. 61/665,567, filed on Jun. 28, 2012.

(51) Int. Cl. F16L 55/172; F16L 55/178

(52) U.S. Cl. CPC F16L 55/172; F16L 55/178
USPC 138/99

(57) ABSTRACT

A clamp assembly for repairing a leak caused by a hole in a pipe element. The claim assembly has first and second arcuate segments attachable to one another end to end, first and second adjustably tightenable connection members positioned at each end of the first and second segments to form first and second segment joints, first and second seals positionable between the segments and the pipe element on opposite sides of the hole, and first and second sealing plates positioned at the segment joints and positionable between the segments and the pipe element to form a seal at each segment joint.

### CROSS-REFERENCE TO RELATED APPLICATION

This application claims the benefit of the filing date of U.S. Provisional Patent Application No. 61/665,567, filed Jun. 28, 2012, which is hereby incorporated by reference herein in its entirety.

### FIELD

This invention relates to a mechanical assembly for repairing a leak in a pipe element caused by a hole in the pipe element.

### BACKGROUND

It is often a challenge to repair leaks in large diameter pipe elements (i.e., pipe elements with a diameter of 26 inches or greater). Such large diameter pipe elements may, for example, be part of a pipe line transporting abrasive slurries, and therefore portions of the pipe line may be subject to accelerated abrasive wear. The pipe line may also be subject to external corrosion as well as physical damage, both accidental and intentional. Leaks form as holes develop in the pipe elements comprising the pipe line. Repair of such leaks may require that the entire pipe element between joints be replaced, or alternately, the perforated portion of the pipe element be cut out and a new pipe portion cut to size and then welded in place. Either repair method is costly and difficult in execution, requiring significant manpower and often heavy equipment to move the pipe elements in need of repair. Furthermore, such leaks lead to significant lost revenues as the entire pipe line must be shut down in order to effect repair. There is clearly a need for a device and a method for repairing large diameter pipe elements which avoids the disadvantages of current methods and which may be applied without shutting down the pipe line.

### SUMMARY

The invention concerns a clamp assembly for repairing a leak caused by a hole or holes in a pipe element. In one example embodiment, the clamp assembly comprises at least first and second arcuate segments attachable to one another end to end. The segments are positionable surrounding the pipe element. At least one of the segments overlies the hole. Each of the segments has an inner surface positionable in facing relation with an outwardly facing surface of the pipe element. First and second adjustably tightenable connection members are positioned at each end of the at least first and second segments. The connection members form first and second segment joints. In this example embodiment, at least a first and a second seal are positionable in spaced apart relation along the pipe element on opposite sides of the hole. The first and second seals are further positionable between the inner surfaces of the segments and the outwardly facing surface of the pipe element. At least first and second sealing plates are positioned, respectively, at the first and second segment joints. The sealing plates are positionable between the inner surfaces of the segments and the outwardly facing surface of the pipe element to form a seal at each of the first and second segment joints.

In one example embodiment of the clamp assembly, the connections members comprise projections extending outwardly from each of the ends of each of the at least first and second segments. A plurality of fasteners extend between the projections and connect the segments end to end. The fasteners are adjustably tightenable to draw the segments toward the pipe element to compress the at least first and second seals and the at least first and second sealing plates between the inner surfaces of the segments and the outwardly facing surface of the pipe element.

In a particular example embodiment, the first and second sealing plates comprise a substantially rigid substrate overlying a conformable substrate. In another example embodiment, the first and second seals each comprise an O-ring. Again by way of example, each of the at least first and second arcuate segments may comprise first and second troughs positioned respectively in the inner surfaces. The troughs are sized to receive at least a portion of the O-rings. Portions of the inner surface within the first and second troughs may be angularly oriented with respect to one another.

In yet another example of the clamp assembly according to the invention, each of the sealing plates may further comprise at least one finger projecting outwardly therefrom. The finger may pass between the ends of the at least first and second segments.

The invention also encompasses a method for repairing a leak in a pipe element caused by a hole therein. In one example, the method comprises:

positioning a first and a second seal in spaced apart relation on opposite sides of the hole and surrounding the pipe element;

positioning at least a first and a second arcuate segment in end to end relation surrounding the pipe element and overlying the first and second seals;

positioning at least a first and a second sealing plate at each of the ends of the at least first and second segments, the sealing plates being positioned between the at least first and second segments and the pipe element; and

drawing the at least first and second segments toward one another so as to compress the first and second seals and the at least first and second sealing plates between the at least first and second segments and the pipe element.

Another step of the method may include splicing the seals after they are positioned surrounding the pipe element.

### BRIEF DESCRIPTION OF THE DRAWINGS

FIG. 1 is an exploded isometric view of an example clamp assembly;

FIG. 2 is an isometric view of a clamp assembly being used to repair a pipe element;

FIGS. 3 and 4 are isometric views illustrating steps in an example method of using a clamp assembly; and

FIG. 5 is a cross sectional view taken at line 5-5 in FIG. 2.

### DETAILED DESCRIPTION

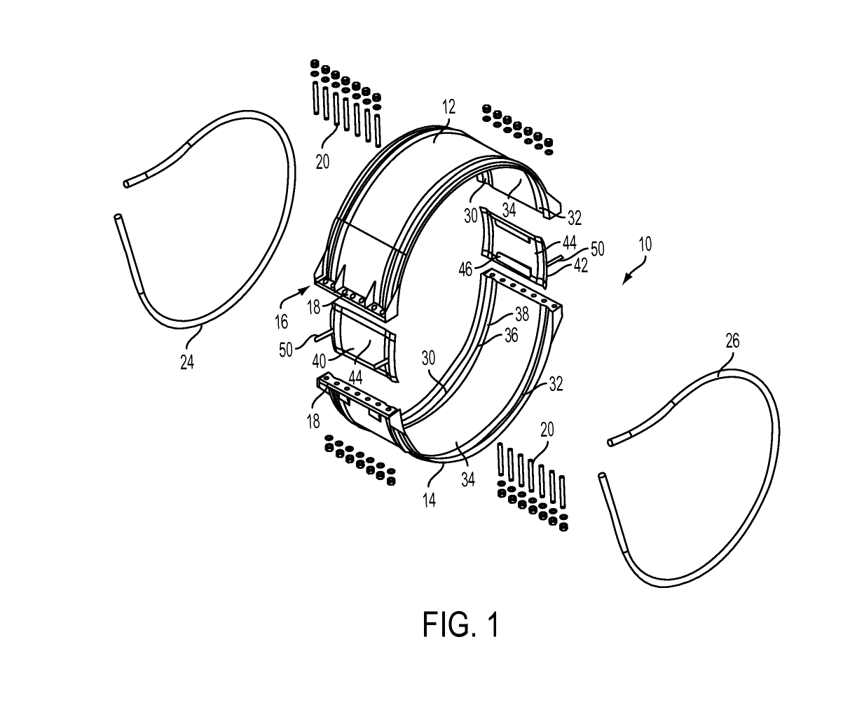

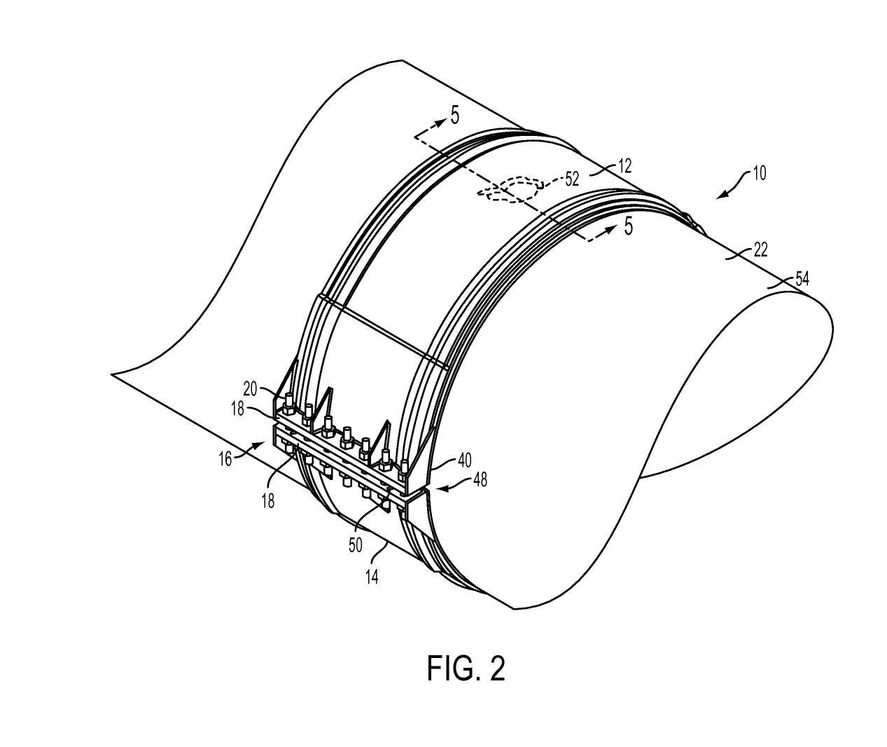

FIG. 1 is an exploded view of an example clamp assembly 10 for repairing a leak caused by a hole in a pipe element. Clamp assembly 10 comprises first and second arcuate segments 12 and 14. The segments are attachable to one another end to end for positioning the clamp assembly 10 around a pipe element. Attachment of the segments 12 and 14 to one another in this example is effected by connection members 16 in the form of projections 18 which extend radially outwardly from the ends of the segments. The connection members 16 are adjustably tightenable through the use of a plurality of fasteners 20 that extend between the projections 18 as shown in FIG. 2. In one example embodiment, the plurality of fasteners 20 can extend through a plurality of openings defined by the projections 18. Tightening of the fasteners 20 allows the segments 12 and 14 to be drawn toward one another and the pipe element 22 during repair as described below. Segments 12 and 14 may be formed, for example, from steel, stainless steel alloys, copper and other metal alloys in a roll forming process. Projections 18 may be integrally formed or welded to the ends of each segment, and gusset plates may be added for increased stiffness and strength. In another example embodiment, the segments may be molded from engineering plastics such as high density polyethylene or polyvinyl chloride as well as composites such as fiberglass or carbon fiber.

With reference again to FIG. 1, clamp assembly 10 further comprises first and second seals 24 and 26. In this example embodiment seals 24 and 26 are split O-rings and have a circular cross section, but it is understood that other forms of seals are feasible. Seals 24 and 26 may be formed of rubber compounds such as EPDM, nitrile and silicone as well as other polymers such as polytetrafluoroethylene (Teflon). As part of the clamp assembly 10, the seals 24 and 26 are received within troughs 30 and 32 on an inner surface 34 of the segments 12 and 14. In this example, troughs 30 and 32 are defined by portions 36 and 38 of the inner surface 34 oriented at an angle to one another. In one example embodiment, the angle formed between portions 36 and 38 of the inner surface 34 can range from about 120 degrees to about 140 degrees. However, it is understood that other angular orientations are feasible. Angularly oriented surface portions 36 and 38 provide advantage in effecting a pressure actuated seal as described below. Other trough shapes, such as semi-circular grooves, are also feasible.

Clamp assembly 10 also comprises first and second sealing plates 40 and 42. The sealing plates in this example comprise a substantially rigid substrate 44 which overlies—and is positioned radially outwardly relative to—a conformable substrate 46. The conformable substrate 46 may be secured to the rigid substrate 44 as shown in FIG. 1. Rigid substrate 44 may be formed from the same material as segments 12 and 14, such as steel, stainless steel alloys, copper and other metal alloys, engineering plastics such as high density polyethylene or polyvinyl chloride as well as composites such as fiberglass or carbon fiber. The conformable substrate may be formed from the same materials as seals 24 and 26, for example, rubber compounds such as EPDM, nitrile and silicone as well as other polymers such as polytetrafluoroethylene. The conformable substrate 46 also acts as a seal to prevent leakage at the segment joints 48 defined by the connection members 16 on each segment 12 and 14 as shown in FIG. 2. As shown in FIG. 1, the conformable substrate 46 may comprise two spaced conformable elements positioned on opposite sides of the segment joints 48, thereby forming a seal to prevent leakage at the segment joints. To assist in the handling and positioning of the sealing plates 40 and 42, one or more fingers 50 may be affixed to the plates. Fingers 50 project outwardly from the plates 40 and 42 and pass between the ends of the segments 12 and 14 at the segment joints 48 as shown in FIG. 2.

Additional example embodiments of sealing plates may be found in U.S. Pat. No. 4,664,428, U.S. Pat. Nos. 5,286,064 and 5,383,496, all three patents hereby incorporated herein in their entirety.

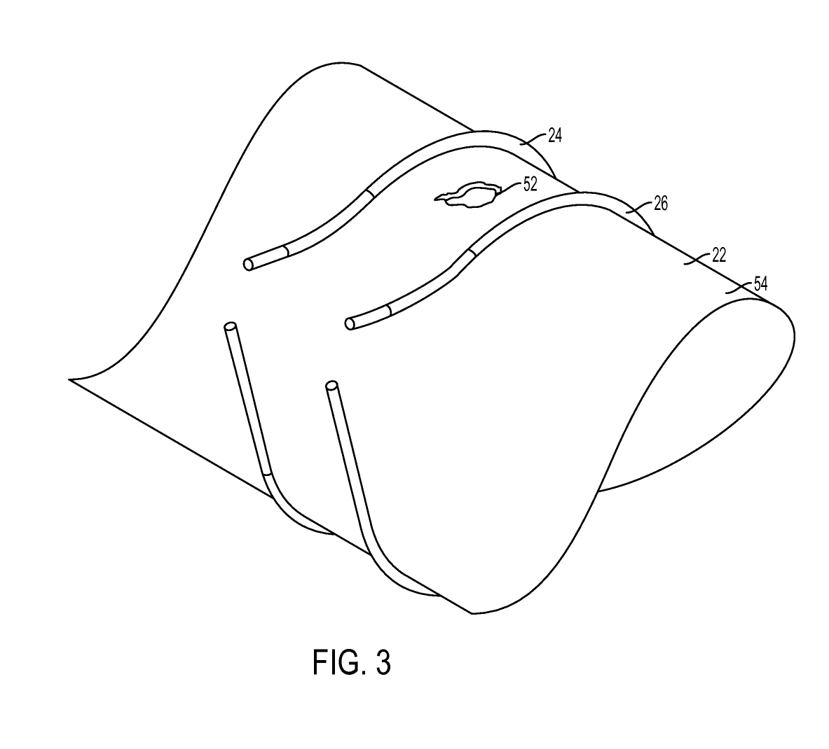

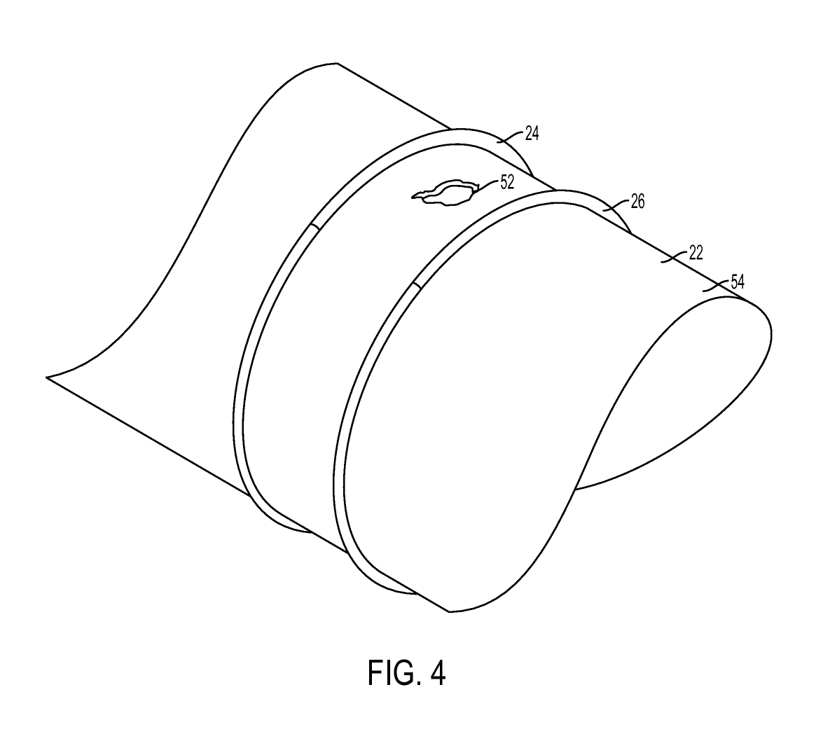

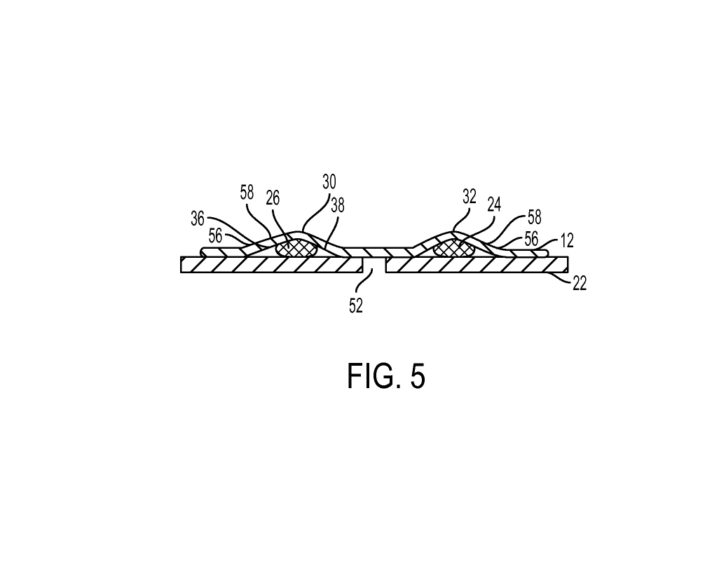

Use of the clamp assembly to repair a leak in a pipe element 22 is demonstrated first with reference to FIG. 3. Pipe element 22 has a hole 52, and the split O-ring seals 24 and 26 are positioned in spaced apart relation on opposite sides of the hole 52, surrounding the pipe element. The O-ring seals 24 and 26 are split to permit them to be positioned surrounding the pipe element without the need for a free end. The ends of the seals 24 and 26 are then spliced as shown in FIG. 4, and the segments 12 and 14 are positioned in end to end relation surrounding the pipe element and overlying the seals 24 and 26 as shown in FIG. 2. The spaced apart relation of the seals 24 and 26 corresponds to the spacing of the troughs 30 and 32 in the segments 12 and 14, allowing the seals to be respectively received within the troughs. Contemporaneously, sealing plates 40 and 42 (40 being shown) are positioned at each of the ends (joints 48) of the segments 12 and 14. The sealing plates 40 and 42 are positioned between the segments 12 and 14 and the outwardly facing surface 54 of the pipe element 22. The segments 12 and 14 are then drawn toward one another, in this example embodiment by tightening the fasteners 20 joining the projections 18. This compresses the seals 24 and 26 and the conformable substrate 46 of the sealing plates 40 and 42 between the inner surface 34 of the segments and the outwardly facing surface 54 of the pipe element to effect a fluid tight seal between the clamp assembly 10 and the pipe element 22, thereby isolating and sealing the hole 52. FIG. 5 shows in detail an example embodiment wherein seals 24 and 26 are compressed between segment 12 and the pipe element 22 in the vicinity of the hole 52. Note that the angularly oriented trough surface portions 36 and 38 forming the troughs 30 and 32 have a tapered profile 56 on the outboard sides 58 of the segments 12 and 14 (12 shown). This tapered profile 56 permits the seals 24 and 26 to be pressure activated by the hydraulic pressure of the fluid within the pipe element 22 exiting from the hole 52. In addition to the radial compression afforded by the segments when they are drawn together the hydraulic pressure of the fluid within the pipe element compresses the seals outboard into the tapered profiles 56, thereby increasing their sealing effect.

Pipe repair clamp assemblies and methods of repair according to the invention promise to significantly shorten the time and reduce the effort required to effect repair of leaking pipes, and, under certain circumstances, will permit repairs to be effected without shutting the pipeline down.

What is claimed is:

1. A clamp assembly for repairing a leak caused by a hole in a pipe element, said clamp assembly comprising:
at least first and second arcuate segments attachable to one another end to end, said segments being positionable surrounding said pipe element, wherein at least one of said segments overlies said hole, each of said segments having an inner surface positionable in facing relation with an outwardly facing surface of said pipe element;
first and second adjustably tightenable connection members positioned at each end of said at least first and second segments and forming first and second segment joints;
at least a first and a second seal positionable in spaced apart relation along said pipe element on opposite sides of said hole, said first and second seals being positionable between said inner surfaces and said outwardly facing surface; and
at least first and second sealing plates, each being positioned respectively at said first and second segment joints, said sealing plates being positionable between said inner surfaces and said outwardly facing surface to form a seal at each of said first and second segment joints.

2. The clamp assembly according to claim 1, wherein said connection members comprise:
projections extending outwardly from each of said ends of each of said at least first and second segments;
a plurality of fasteners extending between said projections and connecting said segments end to end, said fasteners being adjustably tightenable and drawing said segments toward said pipe element to compress said at least first and second seals and said at least first and second sealing plates between said inner surfaces and said outwardly facing surface.

3. The clamp assembly according to claim 1, wherein said first and second sealing plates comprise a substantially rigid substrate overlying a conformable substrate.

4. The clamp assembly according to claim 1, wherein said first and second seals each comprise an O-ring.

5. The clamp assembly according to claim 4, wherein each of said at least first and second arcuate segments comprise first and second troughs positioned respectively in said inner surfaces, said troughs being sized to receive at least a portion of said O-rings.

6. The clamp assembly according to claim 5, wherein portions of said inner surface within said first and second troughs are angularly oriented with respect to one another.

7. The clamp assembly according to claim 6, wherein said at least first and second arcuate segments have outboard sides, and wherein said angularly oriented portions of said inner surface within said first and second troughs have a tapered profile on said outboard sides of said at least first and second arcuate segments.

8. The clamp assembly according to claim 1, wherein each of said sealing plates further comprises at least one finger projecting outwardly therefrom and passing between said ends of said at least first and second segments.

9. A clamp assembly for repairing a leak caused by a hole in a pipe element, said clamp assembly comprising:
at least first and second arcuate segments attachable to one another end to end, said segments being positionable surrounding said pipe element, wherein at least one of said segments overlies said hole, each of said segments having an inner surface positionable in facing relation with an outwardly facing surface of said pipe element;
first and second adjustably tightenable connection members positioned at each end of said at least first and second segments and forming first and second segment joints, said first and second adjustably tightenable connection members comprising:
projections extending outwardly from each of said ends of each of said at least first and second segments; and
a plurality of fasteners extending between said projections and connecting said segments end to end;
at least a first and a second seal positionable in spaced apart relation along said pipe element on opposite sides of said hole, said first and second seals being positionable between said inner surfaces and said outwardly facing surface; and
at least first and second sealing plates, each being positioned respectively at said first and second segment joints, said sealing plates being positionable between said inner surfaces and said outwardly facing surface to form a seal at each of said first and second segment joints,
wherein said fasteners of said connection members are adjustably tightenable and configured to draw said segments toward said pipe element to compress said at least first and second seals and said at least first and second sealing plates between said inner surfaces and said outwardly facing surface.

10. The clamp assembly according to claim 9, wherein said first and second sealing plates comprise a substantially rigid substrate overlying a conformable substrate.

11. The clamp assembly according to claim 9, wherein said first and second seals each comprise an O-ring.

12. The clamp assembly according to claim 11, wherein each of said at least first and second arcuate segments comprise first and second troughs positioned respectively in said inner surfaces, said troughs being sized to receive at least a portion of said O-rings.

13. The clamp assembly according to claim 12, wherein portions of said inner surface within said first and second troughs are angularly oriented with respect to one another.

14. The clamp assembly according to claim 13, wherein said at least first and second arcuate segments have outboard sides, and wherein said angularly oriented portions of said inner surface within said first and second troughs have a tapered profile on said outboard sides of said at least first and second arcuate segments.

15. The clamp assembly according to claim 9, wherein each of said sealing plates further comprises at least one finger projecting outwardly therefrom and passing between said ends of said at least first and second segments.

16. A method for repairing a leak in a pipe element caused by a hole therein, said method comprising:
positioning a first and a second seal in spaced apart relation on opposite sides of said hole and surrounding said pipe element;
positioning at least a first and a second arcuate segment in end to end relation surrounding said pipe element and overlying said first and second seals;
positioning at least a first and a second sealing plate at each of said ends of said at least first and second segments, said sealing plates being positioned between said at least first and second segments and said pipe element; and
drawing said at least first and second segments toward one another so as to compress said first and second seals and said at least first and second sealing plates between said at least first and second segments and said pipe element.

17. The method according to claim 16, further comprising splicing each one of said first and second seals after positioning said seals on said pipe element.

18. The method according to claim 17, wherein first and second troughs are positioned respectively in inner surfaces of said at least first and second segments, and wherein the step of positioning at least said first and second segments in end to end relation comprises positioning said at least first and second segments surrounding said pipe element and overlying said first and second seals such that said first and second seals are respectively received within said first and second troughs.
